(19) United States
(12) Patent Application Publication
(10) Pub. No.: US 2014/0141222 A1
(43) Pub. Date: May 22, 2014

(54) TRANSPARENT SUBSTRATE CLAD WITH A STACK OF MINERAL LAYERS ONE OF WHICH IS POROUS AND COVERED

(71) Applicant: François Guillemot, Paris (FR)

(72) Inventor: François Guillemot, Paris (FR)

(73) Assignee: SAINT-GOBAIN GLASS FRANCE, Courbevoie (FR)

(21) Appl. No.: 14/115,601

(22) PCT Filed: Apr. 30, 2012
(86) PCT No.: PCT/FR2012/050965

§ 371 Date: Jan. 30, 2014

(30) Foreign Application Priority Data
May 5, 2011 (FR) 1153856

(51) Int. Cl. G02B 1/10; B05D 3/02; B05D 5/06

(52) U.S. Cl. CPC G02B 1/10; B05D 5/063; B05D 3/0254
USPC 428/216; 427/226

(57) ABSTRACT

A transparent substrate coated with a stack of layers including one or more essentially inorganic layer(s) exhibiting a nonzero fraction by volume of at most 74% of pores of 30 to 100 nm and a minimum thickness of at least the dimension of the biggest pores which it contains and, if appropriate, one or more essentially inorganic dense layer(s) with thickness(es) at most equal to 400 nm, provided that two such dense layers are not adjacent and that at least one porous layer is covered with at least one other layer.

The present invention relates to a transparent substrate coated with a stack of functional layers.

These functions can be of an optical nature, such as reflection, coloration in reflection, antireflection or thermal, such as solar-protection (reflection of solar radiation), low-emissivity (reflection of the thermal radiation from the inside of buildings). A stack of layers having a relatively low refractive index alternating with layers having a relatively high refractive index is concerned in particular.

A stack on glass of quarter wavelength layers alternately having a low or high refractive index makes it possible to confer a high reflectivity on the glass. In practice, if the number of stacked layers is high, the reflectivity of the coating is 100% over a wavelength range. This wavelength range becomes broader as the contrast in refractive indices between the layers increases. Stacks of this type are generally denoted under the name of Bragg mirror (Distributed Bragg Reflector or DBR).

An advantageous property of these reflecting stacks is that, if the contrast in refractive indices between the layers is low, the region of reflective wavelengths can become narrower than the visible range: in this case, the substrate appears colored without any of the materials making up the stack being colored.

Reflecting stacks of this type are used in the field of high-tech optics to produce filters or optical cavities.

It might be imagined to deposit the layers by the physical route (Physical Vapor Deposition or PVD) or by the liquid route, using the sol-gel process.

However, magnetron depositions (that is to say, depositions by magnetron-assisted cathode sputtering) of layers of silica or equivalent are expensive and lengthy as a result of the electrical insulating nature of the silica. The layers thus obtained have a refractive index not less than 1.3 approximately.

Moreover, the depositions of the multilayers by the sol-gel route are complex to carry out as a result of the high residual tensile mechanical stresses in the dense layers. These high residual mechanical stresses imply the existence of a critical layer thickness, above which the layer cracks. For example, this thickness has a value of approximately 400 nm for a sol-gel layer of densified silica at 450° C. In order to solve this problem, extremely short high-temperature annealings (Rapid Thermal Annealing or RTA) are then carried out. Each layer is annealed, immediately after its deposition, for a few seconds at most at a temperature as high as approximately 900° C. Of course, each layer is subjected, in addition to its own heat treatment, to that of those of the layer or layers optionally covering it, so that the cumulative duration of heat treatment to which the layer closest to the substrate is subjected can reach several minutes, for example four minutes, this duration comprising cooling phases. These repeated annealing phases are tedious and difficult to operate industrially.

The inventors have thus sought to produce, on a transparent substrate made of glass or equivalent, a stack of layers which can vary within wide ranges in thicknesses and in refractive indices.

This aim can be achieved by the invention, which consequently has as subject matter a transparent substrate coated with a stack of layers comprising one or more essentially inorganic layer(s) exhibiting a nonzero fraction by volume of at most 74% of pores of 30 to 100 nm and a minimum thickness of at least the dimension of the biggest pores which it contains and, if appropriate, one or more essentially inorganic dense layer(s) with thickness(es) at most equal to 400 nm, provided that two such dense layers are not adjacent and that at least one porous layer is covered with at least one other layer.

Within the meaning of the invention, the term “stack” implies the presence of at least two layers. Consequently, if just one porous layer is present, at least one dense layer must also be present.

The term “dense layer” denotes a layer essentially devoid of porosity.

The porosity of the porous layers is easily adjusted so as to provide them with lower refractive indices than those of their dense material, values as low as 1.1 in the case of silica, for example. In this patent application, the refractive indices are given at a wavelength of 600 nm.

The thickness of the dense layers optionally present is necessarily at most equal to 400 nm, so as to prevent cracks originating from the tensile stresses in the thicker layers, as mentioned above.

Furthermore, in accordance with the invention, two such dense layers are necessarily separated by a porous layer, so as to optimally accommodate the tensile stresses in the whole of the stack.

Furthermore, the thickness of each dense layer does not have a lower limit and can be as small as 2 nm.

The inventors have developed a process for the preparation of the substrate provided with its stack, which will be seen in more detail subsequently, in which the tensile stresses undergone in the whole of the stack during the different temperature variations are compensated for by the porous layer or layers, so that the formation of cracks is excluded. The residual stresses in the porous layers are weak, so that it is possible to deposit thereon layers having a thickness which reaches 1 μm, indeed even 2 μm, without observing cracking.

According to the invention, at least one porous layer is covered with at least one other layer. This configuration is simultaneously favorable to the achievement of the desired optical functionalities and unrealizable by known processes. In particular, it is not generally possible to deposit, on a preformed layer having open porosity, another layer by the liquid sol-gel route as the liquid precursor of the latter would be at least partially absorbed in the porosity of the underlying layer.

In each porous layer, the pores can have different dimensions, although this is not preferred. However, it should be noted that the maximum fraction by volume of 74% is the maximum theoretical value applied to a stack of spheres having an identical dimension, whatever it is.

Preferably, the porous and dense layers are composed of identical or different materials chosen from SiO₂, TiO₂, Al₂O₃, SnO₂, ZnO, In₂O₃ and SiOC, alone or as a mixture of several of them.

For the optical and/or thermal, reflection, or anti-reflection, or other properties which it is desired to obtain, it is known to employ thicknesses of layers of a quarter or half of the wavelengths under consideration. On the one hand, the visible wavelengths are between 380 and 780 nm approximately and, on the other hand, it is accepted that most of the solar radiation corresponds to the wavelengths from 400 to 900 nm approximately. To this end, the thickness of each porous layer and of each dense layer is preferably at least equal to 50 nm and preferably at most equal to 500 nm. More specifically, the thickness of the quarter-wave layers is advantageously between 70 and 250 nm and that of the half-wave layers is between 170 and 480 nm.

Preferably, the pores of at least one porous layer are essentially all of identical dimensions; this characteristic is favored by the structuring of this layer by latex during a liquid-route process of sol-gel type.

Advantageously, the stack comprises one or more layers having relatively high refractive index/indices, alternating with one or more layers having relatively low refractive index/indices. This. characteristic means here simply that, in any group of three of these neighboring layers, the two variations in refractive indices between two consecutive layers are necessarily in opposite directions (one increasing and the following one decreasing, or the reverse). This alternation in the layers having a relatively high and respectively a relatively low refractive index can comprise a high number of high index layer/low index layer pairs, for example twenty five. In a reflecting stack, for example, the higher this number, the closer the reflectivity of the stack approaches 1 (100%) until virtually reaching this value.

Furthermore, in this implementation, all the layers with relatively high refractive indices, on the one hand, and with relatively low refractive indices, on the other hand, are preferably composed of the same material and have the same porosity, that is to say have the same refractive index.

Conveniently, the porosity of the layers is used to lower the refractive index in comparison with that of the dense material, and the porous layers can naturally constitute layers with relatively low refractive indices; however, it is not ruled out for them to constitute layers with relatively high refractive indices. Conversely, it is not ruled out for a dense layer to constitute a layer with a relatively low refractive index. For example, a porous TiO₂ layer can have a greater refractive index than that of a dense silica layer. In this respect, it should be remembered that the stack of the substrate of the invention comprises at least just one porous layer and a dense layer, or two porous layers. It can comprise in all only porous layers, or both porous and dense layers.

Another subject matter of the invention is a process for the preparation of a transparent substrate as described above, which is distinguished by the fact that it comprises:
a) the successive alternating deposition of first liquid films comprising a structuring latex, which are precursors of first essentially inorganic porous layers, on the one hand, and of second liquid films comprising a structuring latex, which are precursors of second essentially inorganic porous layers, or not comprising a structuring latex, which are precursors of second essentially inorganic dense layers, on the other hand, and
b) a heat treatment at at least 400° C. for simultaneous densification of all the layers, removal of the latex and structuring of the porous layers.

The latex is preferably an acrylic or styrene latex, stabilized in water by a surfactant, in particular an anionic surfactant.

Extremely advantageously, this process makes it possible to deposit a multiplicity of layers by the liquid route, for example at least ten pairs of porous silica/dense silica layers, and then to carry out'only a single annealing for all these layers. There is no interpenetration of the neighboring layers, the porosity being formed only by the annealing. The latex is removed, no cracking appears.

Another subject matter of the invention is the application of a transparent substrate as described above for the reflection of a light radiation and/or of solar radiation.

The invention is now illustrated by the following implementational example.

### EXAMPLE

### a.—Preparation of the Porous Layers

### Silica Sol

14.2 ml (n_{Si}=6.4×10⁻² mol) of tetraethoxysilane (TEOS), 11.2 ml of ethanol (3n_{Si} mol of ethanol) and 4.62 ml of a solution of hydrochloric acid in deionized water, the pH of which has a value of 2.5 (4n_{Si} mol of water) are introduced into a round-bottomed flask. The mixture is brought to 60° C. for 60 min with stirring.

The objective is thus to prepare a solution comprising the silica precursor at 2.90 mol/l in water, while having removed as much ethanol as possible. In order to obtain the desired concentration, the final volume of solution has to be 22 ml. After the first stage, the sol comprises 7n_{Si} mol of ethanol (initial ethanol, plus ethanol released by the hydrolysis), which corresponds to a volume of 26 ml (the density of ethanol has a value of 0.79).

20 ml of hydrochloric acid solution, the pH of which has a value of 2.5, are added to the sol resulting from the first stage. The mixture is brought under vacuum and gently heated in a rotary evaporator in order to remove the ethanol therefrom. After this stage, the volume of solution is adjusted to 22 ml with the hydrochloric acid solution, the pH of which has a value of 2.5, and the silica sol is ready.

Silica precursor and porogenic agent mixture

In practice, the order of mixing the compounds is determined so as to destabilize the latex as little as possible. For this, the latex and the diluent are mixed first, and then the silica sol is added. This makes it possible to ensure that the concentration of inorganic precursor “seen” by the latex is always less than the final concentration. This precaution is necessary in particular if ethanol is present. This is because destabilization of the latex in the latex+sol mixture after removal of ethanol has not been observed. In general, the mixtures are prepared and then deposited in the hours which follow.

In order to produce the porous layer of the example:
wₛₒₗ (g) 1.88
wₗₐₜₑₓ(g) 1.75
w_{diluent} (g) 6.37

Latex: PMMA particles with a diameter of 50 nm and with a solids content of 20.2%, stabilized in dispersion in water by an anionic surfactant, such as sodium dodecyl sulfate (SDS), a derivative of the latter or equivalent.

Sol: the sol described above (silica sol), solids content 17.4%.

Diluent: a hydrochloric acid solution, the pH of which has a value of 2.5.

### Deposition

The porous layers are deposited by spin coating on glass. The layers are deposited by spin coating at 2000 rev/min for 60 s, after the mixture has been deposited over the entire surface of the substrate using a Pasteur pipette. This stage prior to the rotation has to be carried out cautiously in order to prevent the formation of bubbles. These bubbles, which are very easily formed due to the large amount of surfactant, are generally the source of defects during the deposition.

A following layer can be deposited immediately after stopping the spin coater.

The thickness is approximately 110 nm and the fraction by volume of latex has a value of 65%.

The calcination is carried out at the end (in the example, this is a tempering at 650° C. for 10 min but this can be an annealing at 450° C. for 1 h 30). The thickness is not modified in the heat treatment. The refractive index of this layer is 1.17.

### b.—Preparation of the Dense Layers

### Dense Silica Layer:

14.2 ml (n_{Si}=6.4×10⁻² mol) of tetraethoxysilane (TEOS), 11.2 ml of ethanol (3n_{Si} mol of ethanol) and 4.62 ml of a solution of hydrochloric acid in deionized water, the pH of which has a value of 2.5 (4n_{Si} mol of water) are introduced into a round-bottomed flask. The mixture is brought to 60° C. for 60 min with stirring.

The solids content is 14.35%. It can be adjusted by diluting with ethanol.

The deposition of this sol by spin coating makes it possible to obtain a dense silica layer. In order to obtain a layer with a thickness of 100 nm, the solids content C is 5%. The refractive index of this layer is 1.45.

### Titanium Oxide Layer:

9 ml of titanium tetrabutoxide and 2.9 ml of butanol are introduced into a round-bottomed flask. This mixture is stirred for 10 minutes in order to homogenize (the liquids are viscous) and is stored at 4° C. for several hours.

6.5 g of the preceding mixture and 6.8 ml of acetic acid are mixed in another round-bottomed flask with very vigorous stirring. The medium is brought to 50° C. for 30 minutes and then to 0° C. for 1 hour.

Finally, 2.2 ml of deionized water and 9.4 ml of ethanol are added dropwise to the medium at 0° C. (in an ice bath). Finally, the medium is brought to 50° C. for one hour.

This sol is deposited by spin coating at 2000 revolutions per minute in order to obtain a layer with a thickness after annealing of 90 nm, the refractive index of which has a value of 2.

### c.—Preparation of the Stacks

### 1.—Porous SiO₂/Dense SiO₂

A variable number of porous SiO₂ layer/dense SiO₂ layer pairs is successively deposited as indicated above. An annealing as described above is carried out for ten pairs of layers, then another for the following ten, and so on.

The number of pairs of layers on the various samples is 1, 2, 5, 15 and 25, for which an approximate reflectivity of 0.13, 0.27, 0.63, 0.97 and respectively greater than 0.99 is observed for the wavelengths of between approximately 565 and 645 nm.

### 2.—Porous SiO₂/Dense TiO₂

Two pairs of porous SiO₂ layer/dense TiO₂ layer are deposited. Just one annealing is sufficient.

The transparent substrate thus coated exhibits a reflectivity of at least 0.1 between 350 and 780 nm, with a maximum value of approximately 0.69 for a wavelength of 410 nm.

A blue coloration is observed under normal incidence.

1. A transparent substrate coated with a stack of layers comprising one or more essentially inorganic layer(s) exhibiting a nonzero fraction by volume of at most 74% of pores of 30 to 100 nm and a minimum thickness of at least the dimension of the biggest pores which it contains and, if appropriate, one or more essentially inorganic dense layer(s) with thickness(es) at most equal to 400 nm, provided that two such dense layers are not adjacent and that at least one porous layer is covered with at least one other layer.

2. The transparent substrate as claimed in claim 1, wherein the porous and dense layers are composed of identical or different materials chosen from SiO2, TiO2, Al2O3, SnO2, ZnO, In2O3 and SiOC, alone or as a mixture of several of them.

3. The transparent substrate as claimed in claim 1, wherein the thickness of each porous layer and of each dense layer is at least equal to 50 nm.

4. The transparent substrate as claimed in claim 1, wherein the thickness of each porous layer and of each dense layer is at most equal to 500 nm.

5. The transparent substrate as claimed in claim 1, wherein the pores of at least one porous layer are essentially all of identical dimensions.

6. The transparent substrate as claimed in claim 1, wherein the stack comprises one or more layers with relatively high refractive index/indices, alternating with one or more layers with relatively low refractive index/indices.

7. The substrate as claimed in claim 6, wherein all the layers with relatively high refractive indices, on the one hand, and with relatively low refractive indices, on the other hand, are composed of the same material and have the same porosity.

8. A process for the preparation of a transparent substrate as claimed in claim 1, comprising:
performing the successive alternating deposition of first liquid films comprising a structuring latex, which are precursors of first essentially inorganic porous layers, on the one hand, and of second liquid films comprising a structuring latex, which are precursors of second essentially inorganic porous layers, or not comprising a structuring latex, which are precursors of second essentially inorganic dense layers, on the other hand, and
heat treating at at least 400° C. for simultaneous densification of all the layers, removal of the latex and structuring of the porous layers.

9. A method comprising using a transparent substrate as claimed claim 1 for the reflection of a light radiation and/or solar radiation.

10. A transparent substrate coated with a stack of layers comprising at least one essentially inorganic porous layer exhibiting a nonzero fraction by volume of at most 74% of pores of 30 to 100 nm and a minimum thickness of at least a dimension of the biggest pore thereof and at least one essentially inorganic dense layer with a thickness at most equal to 400 nm, wherein two such dense layers are not in contact with each other.
